(19) United States
(12) Patent Application Publication
(10) Pub. No.: US 2017/0046043 A1
(43) Pub. Date: Feb. 16, 2017

(54) MEMBRANE SWITCH MECHANISM

(71) Applicant: Honeywell International Inc., Morristown, NJ (US)

(72) Inventors: Karen Karg, Morristown, NJ (US); Pallavi Dharwada, Maple Grove, MN (US); Albert Hietkamp, Emmen (NL); Alexandra Emmons, Eagan, MN (US); Stephane Joseph Pierre Beland, St-Jean-sur-Richelieu (CA)

(21) Appl. No.: 14/825,954

(22) Filed: Aug. 13, 2015

(51) Int. Cl. G06F 3/0481; F16K 51/00; F21V 23/04; G06F 3/02; G06F 3/0484

(52) U.S. Cl. CPC G06F 3/04817; G06F 3/02; G06F 3/0484; F21V 23/0442; F16K 51/00; F21Y 2115/10; F21Y 2113/10

(57) ABSTRACT

A mechanism, such as a membrane switch, may incorporate universal symbols making it language independent. Status of switch components may be understood without aid of another device. The components may have, for example, white backlights and/or icons for neutral symbols to convey informational conditions that do not necessarily command immediate attention and may have, for example, color backlights and/or icons for non-neutral symbols to convey informational conditions that command immediate attention. A choice of white may be agnostic to color blindness and provide high contrast. Also, there may be a self-test icon with an indication when there is an on-going test of a system with which the mechanism is associated. Symbols on the face of the mechanism may indicate valve openings and closings, pressures, faults, and so forth. The symbols and associated lights and backlights may be visible for at least a specified distance to a person with normal vision.

### BACKGROUND

The present disclosure pertains to switches and particularly to switches having certain features.

### SUMMARY

The disclosure reveals a mechanism, such as a membrane switch, that may incorporate universal symbols that make it language independent. Status of the switch components may be understood without aid of another device. The components may have, for example, white backlights and/or icons for neutral symbols to convey informational conditions that do not necessarily command immediate attention and may have, for example, color backlights and/or icons for non-neutral symbols to convey informational conditions that command immediate attention. Also, there may be a self-test icon with an indication when there is an on-going test of a system with which the mechanism is associated. Symbols on the face of the mechanism may indicate, for instance, valve openings and closings, pressures, faults, and so forth. The symbols and associated lights and backlights may be visible for at least a specified distance to a person with normal vision. The mechanism may meet various standards and/or regulations for use in observation and control of things such as, for example, valves and/or associated controllers.

### BRIEF DESCRIPTION OF THE DRAWING

FIG. 1a is a diagram of an example membrane switch;

FIG. 1b is a line diagram of the example membrane switch;

FIG. 2 is a diagram of a valve controller incorporating a membrane switch; and

FIGS. 3a, 3b, 3c and 3d are diagrams showing various views of the membrane switch.

### DESCRIPTION

The present system and approach may incorporate one or more processors, computers, controllers, user interfaces, wireless and/or wire connections, and/or the like, in an implementation described and/or shown herein.

This description may provide one or more illustrative and specific examples or ways of implementing the present system and approach. There may be numerous other examples or ways of implementing the system and approach.

The membrane switch may facilitate international comprehension which is a language independent of valve status via universal symbology. The present approach may allow an understanding of a valve status without the aid of another device.

A list of advantages of the present switch may incorporate universal symbols for international comprehension (i.e., language independent), an understanding of status without the aid of another device, white LED color/icons for neutral symbols (i.e., informational conditions that do not require attention), red LED color/icons for conditions requiring attention, a self-test icon with slow blink fade-in/fade-out to indicate an on-going test (for informational purposes), back-lit valve open/closed LEDs for clarity and fulfilling a factory mutual requirement for providing valve open/closed indication visible from at least 5 ft. (1.5 m). The membrane switch may also fulfill the requirement that the absence of light not be used as an indication means. Back-lit valve open/closed LEDs may be for clarity and fulfilling the ANSI Z21.21-2005/CSA 6.5-2005 requirement for valve control in open/closed visual indicators.

There may be intuitive symbols that do not require specific training on interpretation as validated through surfaces. Appropriate affordances may differentiate the reset button on the membrane on the status.

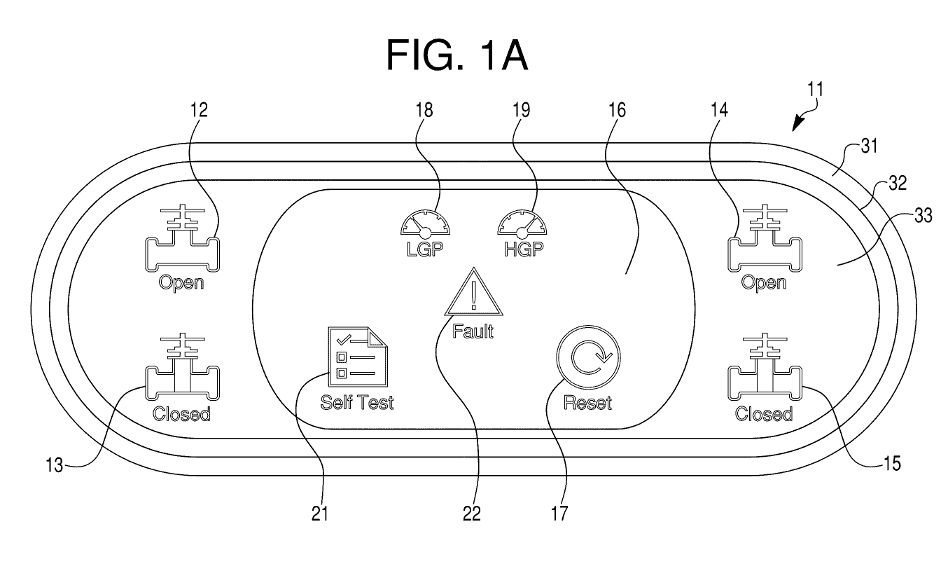

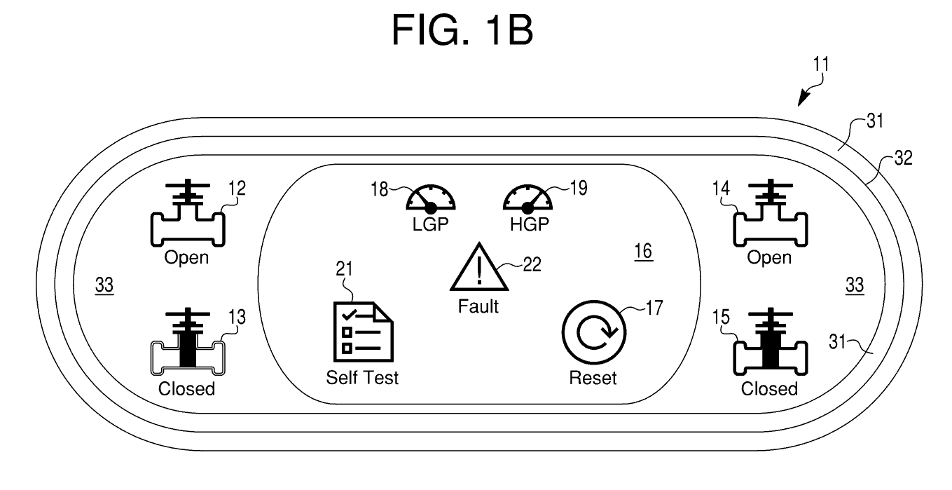

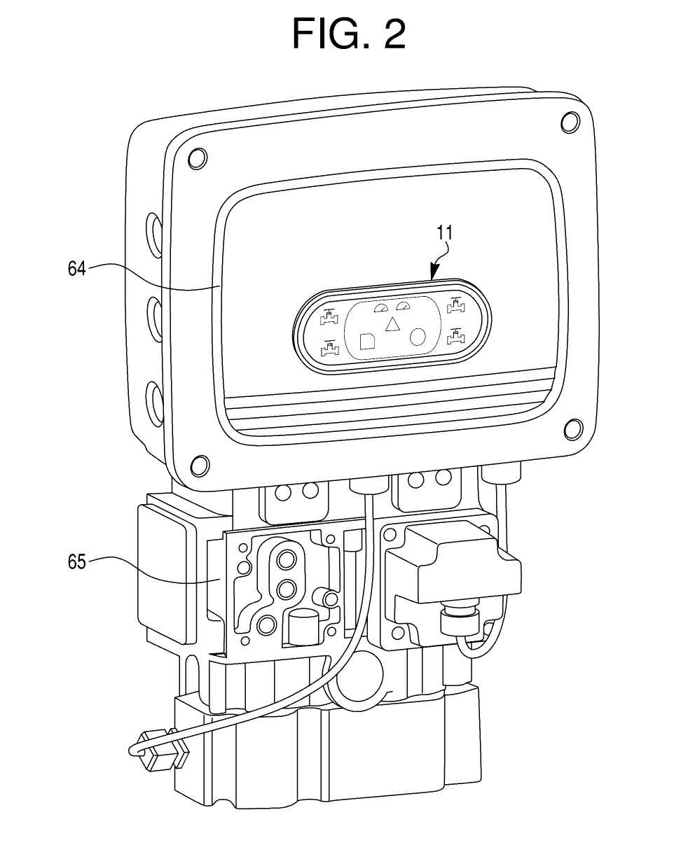

FIG. 1a is a diagram of an example membrane switch 11 that may be a user interface for a valve controller 64 in FIG. 2. FIG. 1b is a line diagram of the diagram in FIG. 1a. Membrane switch 11 may have numerous icons. An open valve icon 12 may be lit when a corresponding gas valve is open. A closed valve icon 13 may be lit when a corresponding valve is closed. If a valve is just partially closed, the valve may considered open. Thus, closed icon 13 may indicate that the respective valve is completely closed. Open valve icon 14 may be similar to icon 12. Closed valve icon 15 may be similar to icon 13. A membrane layout 16 may encompass more or less open valve icons, and closed valve icons relative to icons 12-15. The valve icon layout 16 of switch 11 is an example configuration. There may be other configuration layouts of the icons.

At a center portion 16 of membrane switch 11, may be a reset membrane switch 17 configured as a button-type switch. Switch 17 may be embossed and have a symbol or diagram showing where switch 17 may be located on center portion 16. A perimeter of resent membrane switch 17 may be defined by a button-type background in terms of color, transparency and/or opaqueness. Switch 17 may be activated such as by applying pressure on the switch. Activation of switch 17 may result in a reset signal being sent to valve controller 65. Valve controller 64 may operate one or more valves 65, such a completely opening or closing, or partially opening or closing the one or more valves.

An icon 18 in center portion 16 may indicate a pressure upstream of a gas valve such as being out of a first defined range. The first defined range may be bounded on one end. An icon 19 in center portion 16 may indicate a pressure downstream of the gas valve being out of a second defined range. The second defined range may be bounded at one end.

Icon 18 may have an image of a meter needle pointing in a particular direction indicating a pressure. Icon 19 may have an image of a meter needle pointing in a particular direction to indicate a pressure. The needles of icons 18 and 19 may be substituted with digital, bar or other forms of imagery to indicate a pressure or other parameter. Icons 18 and 19 may be labeled “LGP” and “HGP” signifying low gas pressure and high gas pressure, respectively.

An icon 21 may indicate a self-test in progress. Icon 21 may be back lit while the self-test is in progress. Icon 21 may have a back light that varies or oscillates while the self-test is in progress. The backlight of icon 21 may be white or virtually any other color. Icon 21 may have a reset membrane switch with some amount of pressure exerted on it to initiate the self-test, such as being pressed with a finger.

The light of icon 21 may be regarded as a self-test light. The self-test light may actuate for the following conditions: check of valve software and circuits at an initial power-up; during automatic VPS (valve proving system) testing (external for internally driven); during manual bubble leak test; and while performing a manual test via the HMI (human machine interface) test wizards such as low gas pressure, high gas pressure, and an internal VPS test.

An icon 22 may indicate a fault. Icon 22 may have an image of a triangle with an exclamation mark centered within the triangle. The image of icon 22 may be other symbols besides the triangle. An active indication of a fault by icon 22 may be signaled with a back light causing the image of triangle symbol to be illuminated. Also the image may be illuminated with virtually any colored light such as a red light. Valve icons 12, 13, 14 and 15 may be back lit with white light; however, the valve icons may be back lit with virtually any other color. Meter icons 18 and 19 may be back lit with red light; however, the meter icons may be back lit with virtually any other color.

Icon 17 may be visible on a membrane switch 11 layout without a back light lighting the icon. However, the reset button may have a back light that turns on for a particular period of time when pressed. The color of the back light may be white or virtually any other color.

The back lights of the icons may vary in intensity with various patterns as desired by a designer, operator, user or other associated person. The back lights may be LEDs or other types of sources.

A choice of white is agnostic to color blindness and may further provide high intensity light with high contrast that is bright in dark boiler rooms as well as well-lit factory rooms. Overall, the icon shapes, colors, and placement combined with the behavior (such as fading in and out) may present a highly intuitive and usable display for safety valves.

Switch 11 may have a combination of different colors used to delineate the various portions of the face of the switch. Central portion 16 may be a gray color, for example, 90 percent black. Outside border 31 may be blue with a black line 32 dividing it. An idea behind “Central portion 16 may be a gray color” is to achieve a functional grouping of display elements and distinct separation of valve seats V (valve) 1 and V 2 as represented by icons 12 and 13, and 14 and 15, respectively.

Reset button 17 may be blue with an outline and symbol outline perhaps in a white or some color. A portion 33 between the blue border 31 and central portion 16 may be a black color. The colors may be set with various intensities and hues. The icons may be set in white or another color but may be lit up with backlights of various colors. Examples may be indicated herein.

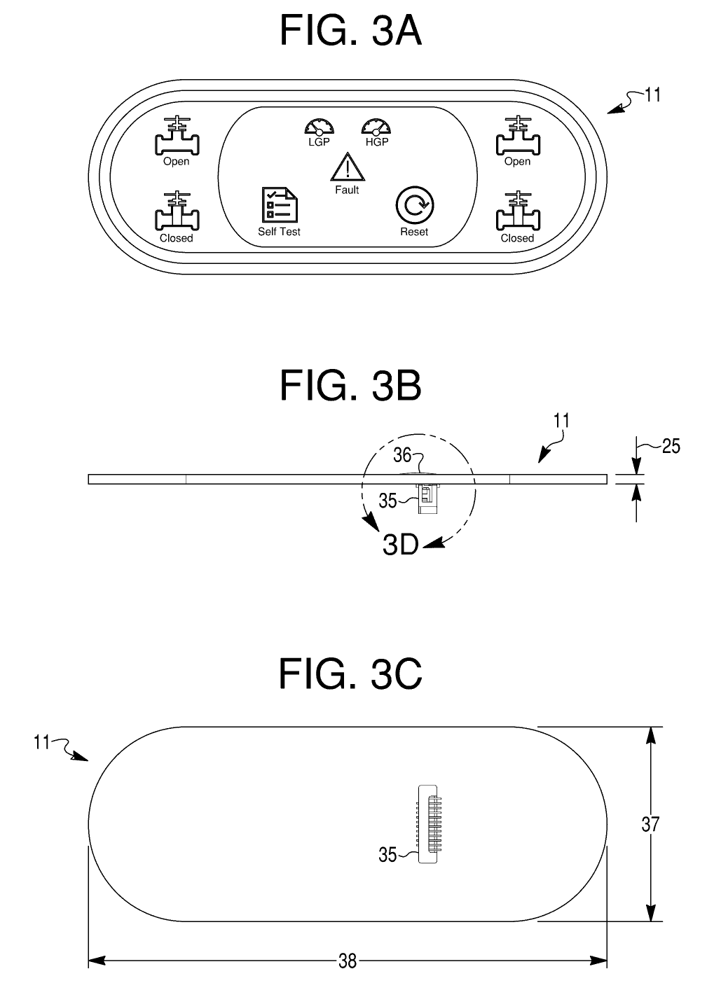

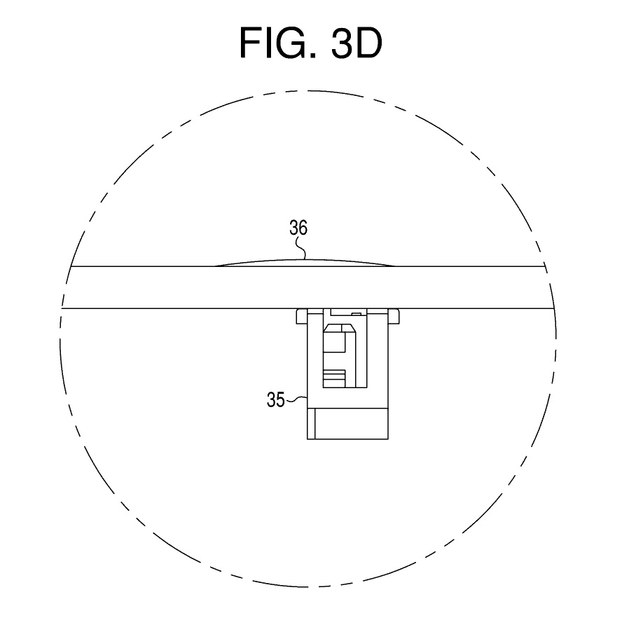

FIGS. 3a, 3b, 3c and 3d are diagrams that reveal structural features and various aspects of membrane switch 11. FIG. 3a may resemble FIGS. 1a and 1b, but reveal an alignment of switch 11 with a side view of switch 11 in FIG. 3b. Various dimensions of switch 11 may be suggested as an illustrative example. Switch 11 may have dimensions other than those stated here. Switch 11 may have a thickness of about 1.93 millimeters (mm) at dimension 25. Construction of switch 11 may have at the top an autotype V8™ graphic overlay, a light guide, a dome switch assembly, a black foam spacer, a PCBA (printed circuit board assembly), and an adhesive with a liner. The adhesive may be a 3M™ 200 MP with the liner. Dimension 25 thickness of switch 11 may be measured without the adhesive liner.

Reset button or switch 17 and other components of switch 11 may be connected to a pin or connector 35 such as a Molex™ 52610-1033. Other connectors or pins of various manufacturers and types may be used. A dome switch 36 without a dimple may be in a proximate location of connector 35. Dome switch 36 may be an external mechanism for reset button or switch 17. Detail within a circle “A” in FIG. 3b may be magnified in a diagram of FIG. 3d. The height of dome switch 36 may be about 0.4 mm and its width may be about 8.9 mm. Dome switch 36 may be activated with about 400 grams of activation force. A life of the switch 36 may be about 6000 cycles with about 1000 cycles with maximum current and 5000 cycles without current. Switch 11 may withstand environmental conditions from minus 40 degrees C. to plus 85 degrees C. at a humidity up to 95 percent. Membrane switch 11 may be also withstand #2 fuel oil and/or UV light without being degraded or discolored. Switch 11 may be used for indoor and outdoor applications.

FIG. 3c is a diagram of a bottom view of switch 11. A width 37 of switch 11 may be about 39 mm. A length 38 of the switch may be about 112 mm.

To recap, a user interface for a gas valve controller that controls a gas valve, may incorporate a first back lit icon that, when back lit, is indicative of a gas valve being in an open position; a second back lit icon that, when back lit, is indicative of the gas valve being in a fully closed position; and a reset membrane switch that, when activated by a user, sends a reset signal to the gas valve controller.

A perimeter of the reset membrane switch may be defined by a button background. The button background may be opaque.

The reset membrane switch may be embossed and the first back lit icon and the second back lit icon are not necessarily embossed.

The first back lit icon, when back lit, may illuminate an image of an open valve. The second back lit icon, when back lit, may illuminate an image of a closed valve. The image of the open valve and the image of the closed valve, when illuminated, may be illuminated in white.

The first back lit icon may be back lit via a first LED, and the second back lit icon may be back lit via a second LED.

The user interface may further incorporate a third back lit icon that, when back lit, is indicative of a gas pressure upstream of the gas valve being out of a first defined range, where the first defined range is bounded on at least one end; and a fourth back lit icon that, when back lit, is indicative of a gas pressure downstream of the gas valve being out of a second defined range, where the second defined range is bounded on at least one end.

The third back lit icon, when back lit, may illuminate an image of a first meter needle pointing in a first direction. The fourth back lit icon, when back lit, may illuminate an image of a second meter needle pointing in a second direction that is different from the first direction. The image of the first meter needle and the image of the second meter needle, when illuminated, may be illuminated in red.

The user interface may further incorporate a fifth back lit icon that, when back lit, is indicative of a self-test light.

The self-test light may actuate for one or more conditions selected from a group having a check of valve software at an initial power-up, circuits at an initial power-up, automatic valve proving system testing, a manual bubble leak test, and performance of a manual test via human machine test wizard of low gas pressure, high gas pressure or an internal valve proving system test.

The fifth back lit icon, when illuminated, may oscillate in intensity while the self-test is in progress.

An activation of the reset membrane switch may initiate the self-test.

The user interface may further incorporate a sixth back lit icon that, when back lit, is indicative of a fault. The sixth back lit icon, when illuminated, may be illuminated in red.

A user interface for a gas valve controller that controls a gas valve, may incorporate a first back lit icon that, when back lit, illuminates an image of an open valve; a second back lit icon that, when back lit, illuminates an image of a closed valve; a third back lit icon that, when back lit, is indicative of a gas pressure upstream of the gas valve being out of a first defined range, where the first defined range is bounded on at least one end; a fourth back lit icon that, when back lit, is indicative of a gas pressure downstream of the gas valve being out of a second defined range, where the second defined range is bounded on at least one end; a fifth back lit icon, that when back lit, is indicative of a self-test in progress; a sixth back lit icon, that when back lit, is indicative of a fault; and a reset membrane switch that, when activated by a user, sends a reset signal to the gas valve controller, where a perimeter of the reset membrane switch is defined by a button background.

The image of the open valve and the image of the closed valve, when illuminated, may be illuminated in white, and where the sixth back lit icon, when illuminated, may be illuminated in red.

A user interface for a gas valve controller that controls a gas valve, may incorporate a first back lit icon that, when back lit, illuminates an image of a first valve in an open position; a second back lit icon that, when back lit, illuminates an image of the first valve in a closed position; a third back lit icon that, when back lit, illuminates an image of a second valve in an open position; a fourth back lit icon that, when back lit, illuminates an image of the second valve in a closed position; a fifth back lit icon that, when back lit, is indicative of a gas pressure upstream of the first and second gas valves being out of a first defined range, where the first defined range is bounded on at least one end; a sixth back lit icon that, when back lit, is indicative of a gas pressure downstream of the first and second gas valves being out of a second defined range, where the second defined range is bounded on at least one end; a seventh back lit icon, that when back lit, is indicative of a self-test in progress; an eighth back lit icon, that when back lit, is indicative of a fault; and a reset membrane switch that, when activated by a user, sends a reset signal to the gas valve controller, where a perimeter of the reset membrane switch is defined by a button background.

The first, second, third and fourth back lit icons may be back lit in white, and the fifth, sixth and eighth back lit icons may be back lit in red.

U.S. patent application Ser. No. 14/107,842, filed Dec. 16, 2013, and entitled “Visual Indicator for a Safety Shut Off Valve”, is hereby incorporated by reference. U.S. patent application Ser. No. 14/521,337, filed Oct. 22, 2014, and entitled “A Valve with Actuator Diagnostics”, is hereby incorporated by reference.

Any publication or patent document noted herein is hereby incorporated by reference to the same extent as if each individual publication or patent document was specifically and individually indicated to be incorporated by reference.

In the present specification, some of the matter may be of a hypothetical or prophetic nature although stated in another manner or tense.

Although the present system and/or approach has been described with respect to at least one illustrative example, many variations and modifications will become apparent to those skilled in the art upon reading the specification. It is therefore the intention that the appended claims be interpreted as broadly as possible in view of the related art to include all such variations and modifications.

What is claimed is:

1. A user interface for a gas valve controller that controls a gas valve, comprising:
a first back lit icon that, when back lit, is indicative of a gas valve being in an open position;
a second back lit icon that, when back lit, is indicative of the gas valve being in a fully closed position; and
a reset membrane switch that, when activated by a user, sends a reset signal to the gas valve controller.

2. The user interface of claim 1, wherein a perimeter of the reset membrane switch is defined by a button background.

3. The user interface of claim 2, wherein the button background is opaque.

4. The user interface of claim 1, wherein the reset membrane switch is embossed and the first back lit icon and the second back lit icon are not embossed.

5. The user interface of claim 1, wherein the first back lit icon, when back lit, illuminates an image of an open valve.

6. The user interface of claim 5, wherein the second back lit icon, when back lit, illuminates an image of a closed valve.

7. The user interface of claim 6, wherein the image of the open valve and the image of the closed valve, when illuminated, are illuminated in white.

8. The user interface of claim 1, wherein the first back lit icon is back lit via a first LED, and the second back lit icon is back lit via a second LED.

9. The user interface of claim 1, further comprising:
a third back lit icon that, when back lit, is indicative of a gas pressure upstream of the gas valve being out of a first defined range, wherein the first defined range is bounded on at least one end; and
a fourth back lit icon that, when back lit, is indicative of a gas pressure downstream of the gas valve being out of a second defined range, wherein the second defined range is bounded on at least one end.

10. The user interface of claim 9, wherein the third back lit icon, when back lit, illuminates an image of a first meter needle pointing in a first direction.

11. The user interface of claim 10, wherein the fourth back lit icon, when back lit, illuminates an image of a second meter needle pointing in a second direction that is different from the first direction.

12. The user interface of claim 11, wherein the image of the first meter needle and the image of the second meter needle, when illuminated, are illuminated in red.

13. The user interface of claim 1, further comprising a fifth back lit icon that, when back lit, is indicative of a self-test light.

14. The user interface of claim 13, wherein the self-test light actuates for one or more conditions selected from a group comprising a check of valve software at an initial power-up, circuits at an initial power-up, automatic valve proving system testing, a manual bubble leak test, and performance of a manual test via human machine test wizard of low gas pressure, high gas pressure or an internal valve proving system test.

15. The user interface of claim 13, wherein the fifth back lit icon, when illuminated, oscillates in intensity while the self-test is in progress.

16. The user interface of claim 13, wherein an activation of the reset membrane switch initiates the self-test.

17. The user interface of claim 1, further comprising a sixth back lit icon that, when back lit, is indicative of a fault.

18. The user interface of claim 17, wherein the sixth back lit icon, when illuminated, is illuminated in red.

19. A user interface for a gas valve controller that controls a gas valve, comprising:
a first back lit icon that, when back lit, illuminates an image of an open valve;
a second back lit icon that, when back lit, illuminates an image of a closed valve;
a third back lit icon that, when back lit, is indicative of a gas pressure upstream of the gas valve being out of a first defined range, wherein the first defined range is bounded on at least one end;
a fourth back lit icon that, when back lit, is indicative of a gas pressure downstream of the gas valve being out of a second defined range, wherein the second defined range is bounded on at least one end;
a fifth back lit icon, that when back lit, is indicative of a self-test in progress;
a sixth back lit icon, that when back lit, is indicative of a fault; and
a reset membrane switch that, when activated by a user, sends a reset signal to the gas valve controller, wherein a perimeter of the reset membrane switch is defined by a button background.

20. The user interface of claim 19, wherein the image of the open valve and the image of the closed valve, when illuminated, are illuminated in white, and wherein the sixth back lit icon, when illuminated, is illuminated in red.

21. A user interface for a gas valve controller that controls a gas valve, comprising:
a first back lit icon that, when back lit, illuminates an image of a first valve in an open position;
a second back lit icon that, when back lit, illuminates an image of the first valve in a closed position;
a third back lit icon that, when back lit, illuminates an image of a second valve in an open position;
a fourth back lit icon that, when back lit, illuminates an image of the second valve in a closed position;
a fifth back lit icon that, when back lit, is indicative of a gas pressure upstream of the first and second gas valves being out of a first defined range, wherein the first defined range is bounded on at least one end;
a sixth back lit icon that, when back lit, is indicative of a gas pressure downstream of the first and second gas valves being out of a second defined range, wherein the second defined range is bounded on at least one end;
a seventh back lit icon, that when back lit, is indicative of a self-test in progress;
an eighth back lit icon, that when back lit, is indicative of a fault; and
a reset membrane switch that, when activated by a user, sends a reset signal to the gas valve controller, wherein a perimeter of the reset membrane switch is defined by a button background.

22. The user interface of claim 21, wherein the first, second, third and fourth back lit icons are back lit in white, and the fifth, sixth and eighth back lit icons are back lit in red.
